(19) United States
(12) Patent Application Publication
(10) Pub. No.: US 2007/0052880 A1
(43) Pub. Date: Mar. 8, 2007

(54) Backlight module with light attenuated thermal expansion gap and liquid crystal display with same

(75) Inventors: Song Lv, Shenzhen (CN); Chih-Hung Chang, MiaoLi (TW); Fei-Hong Chen, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/515,657

(22) Filed: Sep. 5, 2006

(30) Foreign Application Priority Data
Sep. 2, 2005 (CN) 200510037025.X

(51) Int. Cl. G02F 1/1333

(52) U.S. Cl. 349/58

(57) ABSTRACT

An exemplary backlight module (4) includes a frame (44) and a light guide plate (40) received in the frame. The light guide plate has a top light emitting surface (404). The frame and an end (408) of the light guide plate cooperatively define a gap (46) therebetween. The gap has a narrowed exit (462) adjacent to the light emitting surface, whereby light beams are prevented from either or both of leaking out from the end of the light guide plate and leaking out from the gap via the narrowed exit.

### FIELD OF THE INVENTION

The present invention relates to backlight modules such as those used in liquid crystal displays (LCDs), and more particularly to a backlight module with a thermal expansion gap configured to prevent excess light exiting therefrom.

### GENERAL BACKGROUND

Liquid crystal displays are commonly used as display devices for compact electronic apparatuses, because they not only provide good quality images but are also very thin. Because liquid crystal molecules in a liquid crystal display do not emit any light themselves, the liquid crystal molecules have to be lit by a separate light source so as to clearly and sharply display text and images. Therefore, liquid crystal displays usually require a backlight module.

Referring to FIG. 8, a typical backlight module 8 includes a light guide plate 80, a light source 82, and a plastic frame 84. The light guide plate 80 and the light source 82 are received in the plastic frame 84. The light guide plate 80 includes a side light incident surface 802, a top light emitting surface 804 adjoining the light incident surface 802, a bottom surface 806, and a side surface 808 at an opposite side of the light guide plate 80 to the light incident surface 802. The light source 82 is located adjacent to the light incident surface 802 of the light guide plate 80, and includes an illuminator 822 and a reflector 824 partially enclosing the illuminator 822. The plastic frame 84 has an inner side surface 842 opposite and parallel to the side surface 808 of the light guide plate 80. The inner side surface 842 and the side surface 808 are both planar. A gap 86 is defined between the side surface 808 and the inner side surface 842. The gap 86 provides room for the plastic frame 84 and the light guide plate 80 to expand during stability tests performed on the backlight module 8 and when the backlight module 8 is used in high temperature conditions.

In operation of the backlight module 8, light beams emitted from the illuminator 822 are transmitted into the light guide plate 80 through the light incident surface 802, and are converted by the light guide plate 80 to form a surface light source at the light emitting surface 804. During this process, some light beams may be emitted from the side surface 808 and strike the inner side surface 842 of the plastic frame 84. Some of the light beams striking the inner side surface 842 are absorbed thereat, and other light beams are reflected back into the gap 86 and may emit from the backlight module 8 via the gap 86. When this occurs, the brightness of the backlight module 8 in an area between the light guide plate 80 and the plastic frame 84 appears stronger than would otherwise be the case. That is, a uniformity of brightness of the backlight module 8 is degraded. Moreover, some of the light beams emitted from the side surface 808 of the light guide plate 80 transmit to a bottom of the gap 86 and are absorbed by the plastic frame 84 thereat. Such light beams are lost, and thus a light utilization ratio of the backlight module 8 is decreased.

What is needed, therefore, is a backlight module that can overcome the above-described deficiencies. What is also need is a liquid crystal display employing such a backlight module.

### SUMMARY

In a preferred embodiment, a backlight module includes a frame and a light guide plate received in the frame. The light guide plate has a top light emitting surface. The frame and an end of the light guide plate cooperatively define a gap therebetween. The gap has a narrowed exit adjacent to the light emitting surface, whereby light beams are prevented from either or both of leaking out from the end of the light guide plate and leaking out from the gap via the narrowed exit. The end can also be jagged for preventing light beams from leaking out from the light guide plate therethrough.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present backlight module and liquid crystal display. In the drawings, like reference numerals designate corresponding parts throughout various views, and all the views are schematic.

FIG. 1 is a side, cross-sectional view of a backlight module according to a first embodiment of the present invention.

FIG. 2 is a side, cross-sectional view of a backlight module according to a second embodiment of the present invention.

FIG. 3 is a side, cross-sectional view of a backlight module according to a third embodiment of the present invention.

FIG. 4 is a side, cross-sectional view of a backlight module according to a fourth embodiment of the present invention.

FIG. 5 is a side, cross-sectional view of a backlight module according to a fifth embodiment of the present invention.

FIG. 6 is a side, cross-sectional view of a backlight module according to a sixth embodiment of the present invention.

FIG. 7 is an exploded, side cross-sectional view of a liquid crystal display according to a seventh embodiment of the present invention.

FIG. 8 is a side, cross-sectional view of a conventional backlight module.

### DETAILED DESCRIPTION OF PREFERRED EMBODIMENTS

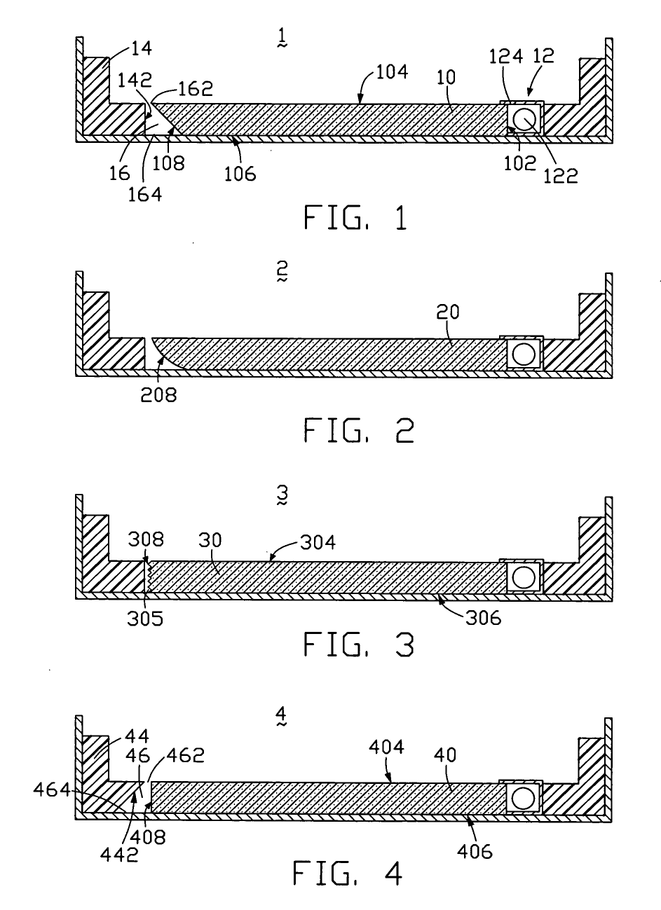

Reference will now be made to the drawings to describe the preferred embodiments in detail. [0018] Referring to FIG. 1, a backlight module 1 according to a first embodiment of the present invention includes a light guide plate 10, a light source 12, and a frame 14. The light guide plate 10 and the light source 12 are received in the frame 14. The light guide plate 10 includes a side light incident surface 102, a top light emitting surface 104 perpendicular to the light incident surface 102, a bottom surface 106, and a side surface 108 at an opposite side of the light guide plate 10 to the light incident surface 102. The side surface 108 is planar, and maintains a predetermined acute angle relative to the light emitting surface 104. The light source 12 is located adjacent to the light incident surface 102, and includes an illuminator 122 and a reflector 124 partially enclosing the illuminator 122. The frame 14 has an inner side surface 142 adjacent to the side surface 108. The inner side surface 142 is planar, and is perpendicular to the light emitting surface 104. Thus a right-angled substantially trapezoid-shaped gap 16 is defined between the light guide plate 10 and the frame 14. The gap 16 has a narrow top exit 162 coplanar with the light emitting surface 104, and a wide bottom exit 164 opposite to the top exit 162. The light guide plate 10 can be made from polycarbonate (PC) or polymethyl methacrylate (PMMA), and can be manufactured by an injection molding method. The frame 14 can be made from white polycarbonate, plastic, or any other suitable material. The illuminator 122 can be a cold cathode fluorescent lamp (CCFL), or at least one light emitting diode (LED).

In operation, light beams emitted from the illuminator 122 are transmitted through the light incident surface 102 into the light guide plate 10, and are then converted by the light guide plate 10 to serve as a surface light source at the light emitting surface 104. During this process, some light beams strike the side surface 108 of the light guide plate 10, with incident angles of the light beams being greater than a critical angle of the side surface 108. With the above-described configuration, substantially total reflection occurs at the side surface 108, whereby the light beams are prevented from leaking out from the side surface 108. Thus a brightness of the backlight module 1 at the top exit 162 between the light guide plate 10 and the frame 14 is not unduly strong, and a high level of brightness uniformity of the backlight module 1 can be achieved. Moreover, because the light beams are prevented from leaking out from the light guide plate 10 through the side surface 108, there is little or no loss of light at the bottom exit 164. Instead, the light reflected at the side surface 108 transmits within the light guide plate 10 toward the light emitting surface 104. Thus the overall light utilization ratio of the backlight module 1 is increased.

Referring to FIG. 2, a backlight module 2 according to a second embodiment of the present invention is similar to the backlight module 1. However, a light guide plate 20 of the backlight module 2 has an outwardly curved side surface 208. The backlight module 2 has advantages similar to those described above in relation to the backlight module 1.

Referring to FIG. 3, a backlight module 3 according to a third embodiment of the present invention is similar to the backlight module 1. However, a light guide plate 30 of the backlight module 3 has a jagged side surface 308, thus defining a plurality of V-shaped grooves 305 thereat. When light beams in the light guide plate 30 strike the side surface 308, most of the light beams are reflected back by surface portions defining the V-shaped grooves 305, and transmit toward a top light emitting surface 304 perpendicular to the side surface 308 or a bottom surface 306 opposite to the light emitting surface 304. That is, most of the light beams can be prevented from leaking out from the side surface 308 of the light guide plate 30.

Referring to FIG. 4, a backlight module 4 according to a fourth embodiment of the present invention is similar to the backlight module 1. However, a light guide plate 40 of the backlight module 4 includes a top light emitting surface 404, a bottom surface 406 opposite to the light emitting surface 404, and a side surface 408 between the light emitting surface 404 and the bottom surface 406. The side surface 408 is planar, and is perpendicular to the light emitting surface 404 and the bottom surface 406. A frame 44 of the backlight module 4 has an inner side surface 442 adjacent to the side surface 408 of the light guide plate 40. The inner side surface 442 is planar, and maintains a predetermined obtuse angle relative to the light emitting surface 404 of the light guide plate 40. Thus, a right-angled substantially trapezoid-shaped gap 46 is defined between the light guide plate 40 and the frame 44. The gap 46 has a narrow top exit 462 coplanar with the light emitting surface 404, and a wide bottom exit 464 opposite to the top exit 462.

With this configuration, at least some if not most of light beams that emit from the side surface 408 strike the inner side surface 442. The light beams that strike the inner side surface 442 are either absorbed or reflected. Most of the reflected light beams transmit either toward a bottom surface (not labeled) of a frame portion of the backlight module 4 that adjoins the frame 44, or back into the light guide plate 40 through the side surface 408. Most of the light beams that strike the bottom surface of the frame portion are either absorbed, or reflected toward the inner side surface 442 or back into the light guide plate 40 through the side surface 408. That is, most of the light beams in the gap 46 do not leak out from the top exit 462 thereof. Thus, a brightness of the backlight module 4 at the top exit 462 between the light guide plate 40 and the frame 44 is not unduly strong, and a high level of brightness uniformity can be achieved for the backlight module 4. Moreover, at least some of the light beams that emit from the side surface 408 of the light guide plate 40 are directly or indirectly reflected back into the light guide plate 40 through the side surface 408. As a result, the light utilization ratio of the backlight module 4 is improved.

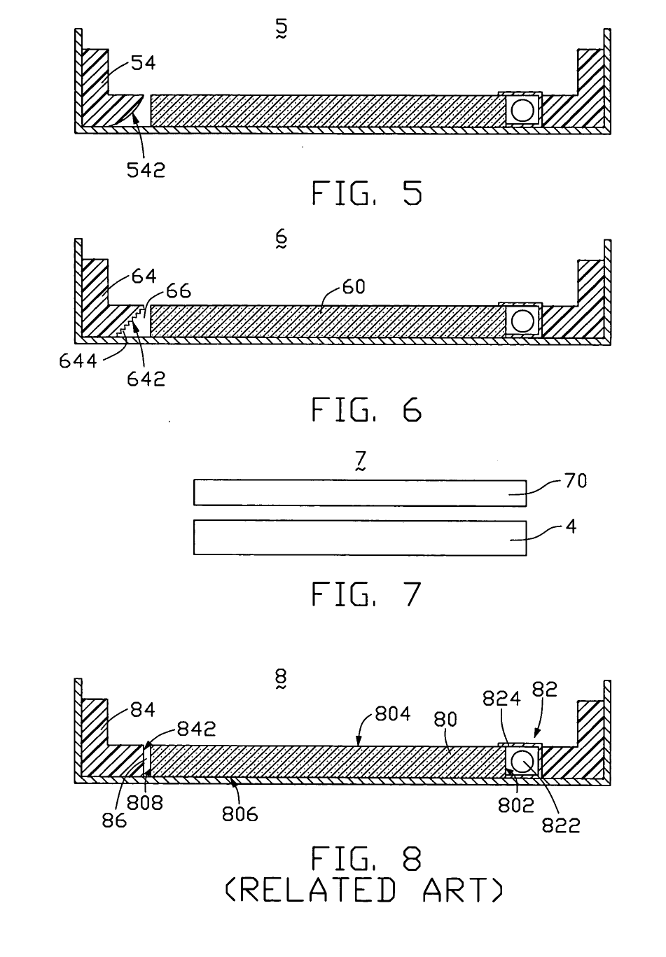

Referring to FIG. 5, a backlight module 5 according to a fifth embodiment of the present invention is similar to the backlight module 4. However, a frame 54 of the backlight module 5 has an outwardly curved inner side surface 542. The backlight module 5 has advantages similar to those described above in relation to the backlight module 4.

Referring to FIG. 6, a backlight module 6 according to a sixth embodiment of the present invention is similar to the backlight module 4. However, a frame 64 of the backlight module 6 has a jagged inner side surface 642, thus defining a plurality of V-shaped grooves 644 thereat. When light beams from a light guide plate 60 of the backlight module 6 strike the inner side surface 642, the light beams are either absorbed or reflected by surface portions defining the V-shaped grooves 644. Most of the reflected light beams transmit either toward a bottom surface (not labeled) of a frame portion of the backlight module 6 that adjoins the frame 64, or back into the light guide plate 60 through a side surface (not labeled) thereof. Most of the light beams that strike the bottom surface of the frame portion are either absorbed, or reflected toward the inner side surface 642 or back into the light guide plate 60 through the side surface thereof. That is, most of the light beams in a gap 66 between the light guide plate 60 and the inner side surface 642 do not leak out from a top exit (not labeled) of the gap 66.

Referring to FIG. 7, a liquid crystal display 7 according to a seventh embodiment of the present invention is shown. The liquid crystal display 7 includes a liquid crystal panel 68 and the above-described backlight module 1. The backlight module 1 is positioned adjacent to the liquid crystal panel 68. The liquid crystal display 7 has a high level of brightness uniformity. In alternative embodiments, the backlight module 1 can be replaced with any one of the above-described backlight modules 2 to 6.

Further or alternative embodiments may include the following. In one example, the light guide plate may include two or three side surfaces, each oriented at an oblique angle relative to the light emitting surface thereof. In another example, the light guide plate may include two or three side surfaces each perpendicular to the light emitting surface. In such case, the frame receiving the light guide plate can have two or three oblique inner side surfaces adjacent to the side surfaces of the light guide plate respectively. In a further example, a plurality of diffusing dots may be arranged at the bottom surface of the light guide plate for improving the uniformity of brightness of the backlight module. In still further examples, any of the above-described inner side surfaces of the respective frames and any of the side surfaces of the above-described light guide plates may be combined in a single backlight module. With such configurations, light beams leaking out from respective gaps can be further decreased or even eliminated.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a frame; and
a light guide plate received in the frame, the light guide plate comprising a top light emitting surface;
the frame and an end of the light guide plate cooperatively defining a gap therebetween;
wherein the gap has a narrowed exit adjacent to the light emitting surface,
whereby light beams are prevented from either or both of leaking out from the end of the light guide plate and leaking out from the gap via the narrowed exit.

2. The backlight module in claim 1, wherein the light guide plate further comprises a side surface adjoining the light emitting surface, and a bottom surface.

3. The backlight module in claim 2, wherein the side surface maintains a predetermined acute angle relative to the light emitting surface.

4. The backlight module in claim 3, wherein a critical angle of the side surface is less than incident angles of light beams striking the side surface from within the light guide plate.

5. The backlight module in claim 4, wherein the side surface is planar.

6. The backlight module in claim 4, wherein the side surface is curved.

7. The backlight module in claim 2, wherein the frame comprises an inner side surface adjacent to the side surface of the light guide plate.

8. The backlight module in claim 7, wherein the inner side surface is oriented at a predetermined obtuse angle relative to the light emitting surface of the light guide plate.

9. The backlight module in claim 8, wherein most of light beams that strike the inner side surface are reflected therefrom.

10. The backlight module in claim 9, wherein the inner side surface is planar.

11. The backlight module in claim 9, wherein the inner side surface is curved.

12. The backlight module in claim 8, wherein the inner side surface is jagged.

13. The backlight module in claim 1, wherein the frame is made from white polycarbonate.

14. The backlight module in claim 1, wherein the frame is made from plastic.

15. A backlight module comprising:
a frame having an inner side surface; and
a light guide plate received in the frame, the light guide plate comprising an end facing the inner side surface;
wherein the end is jagged for preventing light beams from leaking out from the light guide plate therethrough.

16. A liquid crystal display comprising:
a liquid crystal panel; and
a backlight module positioned adjacent to the liquid crystal panel, the backlight module comprising:
a frame; and
a light guide plate received in the frame, the light guide plate comprising a top light emitting surface;
the frame and an end of the light guide plate cooperatively defining a gap therebetween;
wherein the gap has a narrowed exit adjacent to the light emitting surface,
whereby light beams are prevented from either or both of leaking out from the end of the light guide plate and leaking out from the gap to the liquid crystal panel via the narrowed exit.
